(19) United States
(12) Patent Application Publication
(10) Pub. No.: US 2015/0096355 A1
(43) Pub. Date: Apr. 9, 2015

(54) FAILURE DETERMINATION DEVICES FOR FUEL VAPOR PROCESSING SYSTEMS

(71) Applicant: AISAN KOGYO KABUSHIKI KAISHA, Obu-shi (JP)

(72) Inventors: Katsuhiko MAKINO, Chita-gun (JP); Mamoru YOSHIOKA, Nagoya-shi (JP); Minoru AKITA, Ama-shi (JP); Masanobu SHINAGAWA, Ama-shi (JP)

(73) Assignee: AISAN KOGYO KABUSHIKI KAISHA, Obu-shi (JP)

(21) Appl. No.: 14/509,504

(22) Filed: Oct. 8, 2014

(30) Foreign Application Priority Data
Oct. 9, 2013 (JP) 2013-211855
Oct. 9, 2013 (JP) 2013-211858

(51) Int. Cl. F02M 25/08; G01M 3/04

(52) U.S. Cl. CPC F02M 25/0818; F02M 25/0836; G01M 3/04; F02M 2025/0845
USPC 73/40.7

(57) ABSTRACT

A failure detecting device for a fuel vapor processing system may include a leakage determination device configured to determine leakage of fuel vapor from a target region of the fuel vapor processing system. The leakage determination device may include a canister closed valve provided in an atmospheric passage connected between a canister and an atmosphere. The canister closed valve may switch between an open position and a closed upon receiving a supply of electric power, and may maintain the open position or the closed position when no electric power is received.

### CROSS-REFERENCE TO RELATED APPLICATIONS

This application claims priority to Japanese patent application serial numbers 2013-211855 and 2013-211858, both filed Oct. 9, 2013, the contents of each are incorporated herein by reference in their entirety for all purposes.

### BACKGROUND

Embodiments disclosed herein relate to failure determination devices for fuel vapor processing systems. The failure determination systems may determine leakage of fuel vapor from fuel vapor processing systems based on a change in pressure of fuel vapor while the fuel vapor processing systems are kept in a hermetically sealed state.

Vehicles that run on fuel such as gasoline may have fuel vapor processing systems. The fuel vapor processing system may avoid damage to a fuel tank caused by an increase of an internal pressure of the fuel tank while inhibiting dissipation of fuel vapor to the atmosphere. However, if a failure (such as creation of cracks in parts of the system or improper sealing of connection portions of the system) occurs, it may be possible that fuel vapor leaks from the system. Even in the case that leakage of fuel vapor has occurred, it may not be possible for a vehicle driver to directly recognize such a failure. To this end, JP-A-2005-344540 and WO2005/001273 propose failure detection devices that can determine leakage of fuel vapor from a fuel vapor processing system.

JP-A-2005-344540 discloses a fuel vapor processing system including a fuel tank and a canister. A pressure sensor may detect a pressure within the fuel vapor processing system. A vent cut valve (also known as a canister closed valve) may be provided in an atmosphere passage through which the canister communicates with the atmosphere. The vent cut valve may serve as a closing device for defining a closed space in the system. During stopping of a vehicle engine, the vent cut valve may be closed for keeping the system in a closed state. The change in pressure and the change in fuel temperature of the system at that time may be used for determining whether or not leakage of fuel vapor is occurring.

However, in JP-A-2005-344540, a normally opening type electromagnetic valve is used as the vent cut valve serving as a closing device. Therefore, in order to keep a closed state for determining the leakage, it is necessary to continuously supply an electric power to the vent cut valve. This may result in an increase in power consumption. Therefore, it may be necessary to avoid repeated leakage determinations and long duration leakage determinations in order to reduce power consumption.

In WO2005/001273, in order to detect leakage of fuel vapor from a fuel vapor processing system, a target region of the system may be brought to a closed state during stopping of a vehicle engine. After that, a pressure may be applied to the target region by utilizing a fuel pump. Then, the leakage may be determined based on a driving time of the fuel pump and a change in pressure after stopping the fuel pump.

However, in the case of WO2005/001273, for determining the leakage of fuel vapor, the fuel pump is driven for applying a pressure to the target region. In other words, the fuel pump must be always driven during determination of the occurrence of leakage of fuel vapor. This may result an increase in power consumption. In addition, in the case of WO2005/001273, if a change in pressure of the target region before driving the fuel pump is large, determination of leakage may not be performed until an engine start key is switched off at the next time.

Therefore, there has been a need in the art for failure determination devices used for fuel vapor processing systems, which can operate for determining leakage with a reduced power consumption.

### SUMMARY

In one aspect according to the present teachings, a failure detecting device for a fuel vapor processing system may include a leakage determination device configured to determine leakage of fuel vapor from a target region of the fuel vapor processing system. The leakage determination device may include a canister closed valve provided in an atmospheric passage connecting between a canister and an atmosphere. The canister closed valve may switch between an open position and a closed upon receiving a supply of electric power, and may maintain the open position or the closed position when no electric power is supplied to the canister closed valve.

### BRIEF DESCRIPTION OF THE DRAWINGS

FIG. 1 is a schematic view showing a fuel vapor processing system incorporating a failure detecting device according to an embodiment;

FIG. 2. is a sectional view of a canister closed valve (CCV) of the failure detecting device;

FIG. 3 is a timing chart showing timings of executing various functions by an ECU for determining leakage and showing operation timings of various components of the failure detecting device;

FIG. 4 is a flowchart showing a Phase 1 (P1) process performed for determining whether or not a failure detecting condition is satisfied;

FIG. 5 is a flowchart showing a Phase 2 (P2) process performed for executing a pre-determination function;

FIG. 6 is a flowchart showing a Phase 3 (P3) process performed after the Phase 2 (P2) process;

FIG. 7 is a sectional view showing another configuration of the CCV; and

FIG. 8 is a schematic view showing another arrangement of the failure detecting device;

FIG. 9 is a schematic view showing a fuel vapor processing system incorporating a failure detecting device according to another embodiment;

FIG. 10 is a sectional view of a jet pump of the failure detecting device;

FIG. 11 is a timing chart showing timings of executing various functions by an ECU in a first failure determination process and showing operation timings of various components of the failure detecting device;

FIG. 12 is a flowchart showing a Phase 1-1 (P1-1) process of the first failure determination process;

FIG. 13 is a flowchart showing a Phase 1-2 (P1-2) process of the first failure determination process;

FIG. 14 is a flowchart showing a Phase 1-3 (P1-3) process of the first failure determination process;

FIG. 15 is a timing chart showing timings of executing various functions by the ECU in a second failure determination process and showing operation timings of various components of the failure detecting device;

FIG. 16 is a flowchart showing a Phase 2-1 (P2-1) process of the second failure determination process;

FIG. 17 is a flowchart showing a Phase 2-2 (P2-2) process of the second failure determination process; and

FIG. 18 is a flowchart showing a Phase 2-3 (P2-3) process of the second failure determination process.

### DETAILED DESCRIPTION

Each of the additional features and teachings disclosed above and below may be utilized separately or in conjunction with other features and teachings to provide improved failure determination devices for fuel vapor processing systems. Representative examples, which utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples. Moreover, various features of the representative examples and the dependent claims may be combined in ways that are not specifically enumerated in order to provide additional useful examples of the present teachings.

In one embodiment, a failure detecting device may be used for a fuel vapor processing system including a fuel tank and a canister. The failure detecting device may include a pressure detecting device configured to detect a pressure within a target region of the fuel vapor processing system, a closing device configured to close the target region, and a leakage determination device configured to determine leakage of fuel vapor from the target region based on a change of pressure within the target region in a closed state of the target region. The closing device may include a canister closed valve (CCV) provided in an atmospheric passage connecting between the canister and an atmosphere. The canister closed valve may be configured to switch between an open position and a closed position upon receiving a supply of electric power, and to maintain the open position or the closed position when no electric power is supplied.

With this arrangement, in order to change between the open position and the closed position of the CCV, it is only necessary to supply an electric power to the CCV. The open position or the closed position may be kept after stopping the supply of the electric power. Therefore, it is possible to considerably reduce the electric power that is necessary for determining leakage of fuel vapor. Thus, it may be possible to perform the leakage determination process during a time longer than the known art with power consumption smaller than or similar to that required in the known art. Hence, it is possible to repeatedly perform the leakage determination process over a long period of time, whereby earlier detection of the occurrence of failure can be made.

The failure detecting device may further include a fuel temperature detecting device configured to detect a temperature of a fuel within the fuel tank. The leakage determination device may be configured to determine leakage of fuel vapor from the target region based on a change of temperature of the fuel in addition to the change of pressure within the target region. With this arrangement, it is possible to improve the accuracy in detection of occurrence of the failure.

The fuel vapor processing system may be used for a vehicle engine. The leakage determination device may include a controller configured to control the CCV and to execute a timer function that may perform a timed leakage determination process, in which a leakage determination operation may be periodically performed with a predetermined time even during stopping of the vehicle engine. In this way, it is possible to reduce the power consumption necessary for the failure detection.

The controller may be configured to execute a pre-determination function before executing the timer function. The pre-determination function may determine that no leakage is occurring if the change of pressure within the target region in the closed state within a predetermined time after closing the target region is out of a predetermined range. The pre-determination function may suspend the determination of leakage if the change of pressure within the target region in the closed state within the predetermined time after closing the target region is within the predetermined range. In general, immediately after stopping the vehicle, it may be possible that the pressure within the target region may increase due to the residual heat of the engine. Therefore, if the pressure within the target region does not increase even after stopping the vehicle, the determination of leakage may not be correctly made. The pre-determination function may avoid unnecessary power consumption. In this respect, it may be possible to further reduce the power consumption.

If the determination of leakage is suspended by the pre-determination function, the controller may open the CCV to reset the pressure within the target region to an atmospheric pressure, and thereafter close the CCV to bring the target region into the closed state. After that, the timed leakage determination process may be performed. Resetting the pressure within the target region to the atmospheric pressure may stabilize the pressure within the target region, so that the leakage can be properly determined. The CCV may be driven by a step motor.

The failure detecting device may further include a mechanical positive and negative pressure relief valve provided in the atmospheric passage and arranged parallel to the CCV. The mechanical positive and negative pressure relief valve may be opened when the pressure within the target region exceeds a predetermined positive pressure or falls blow a predetermined negative pressure. With this arrangement, when the pressure within the target region has become excessively high or excessively low, the mechanical positive and negative pressure relief valve device may automatically open to relieve the pressure. In this way, it may be possible to provide a fail-safe function for preventing an accidental damage to the fuel tank. Therefore, it is not necessary to always adjust the pressure by monitoring the same. In addition, because the relief valve device may mechanically operate to open without need of supply of an electric power, it is possible to save the power consumption.

The leakage determination device may terminate the determination of leakage when a fuel is refueled into the fuel tank. When the fuel is refueled into the fuel tank, it may be possible that the pressure within the target region abruptly increases. In such a case, the leakage determination may not be correctly made. Therefore, by stopping the leakage determination during refueling, it may be possible to further save the power consumption. In addition, because the leakage determination is made while the target region is closed, no damage to the fuel tank may occur.

The pressure detecting device may include a first detecting device configured to detect a pressure within the fuel tank and a second detecting device configured to detect a pressure within the canister. The failure detecting device may further include a shut-off device provided between the fuel tank and the canister and configured to switch between an open position for allowing communication between the fuel tank and the canister and a closed position for interrupting communication between the fuel tank and the canister. When the leakage is to be determined, the shut-off device may be switched to the closed position, so that the determination of leakage can be performed separately for each of a first part of the target region on the side of the fuel tank and for a second part of the target region on the side of the canister.

In another embodiment, the failure detecting device may be used for a fuel vapor processing system including a fuel tank, a canister and a fuel pump. The failure detecting device may include a pressure detecting device configured to detect a pressure within a target region of the fuel vapor processing system, a closing device configured to close the target region, a pressure applying device configured to apply a pressure to the target region and driven by the fuel pump, and a leakage determination device configured to determine leakage of fuel vapor from the target region based on a change of a pressure within the target region in a closed state of the target region. The leakage determination device may have a first failure detection function and a second failure detection function. The first failure detection function may determine whether or not leakage is occurring based on a change of the pressure within the target region without applying the pressure to the target region by the pressure applying device. The second failure detection function may determine whether or not leakage is occurring based on the change of the pressure within the target region after the pressure applying device applies the pressure to the target region. The leakage determination device may execute the second failure detection function only when the determination by the first failure detecting function is suspended.

For example, the first failure detecting function may be periodically performed by a predetermined time, and the second failure detecting function may be executed if a difference between an actual pressure detected by the pressure detecting device and a previously estimated pressure is smaller than a predetermined value. The previously estimated pressure may be that estimated based on the temperature detected by the fuel temperature detecting device during execution of the first failure detecting function that is previously performed.

The fuel vapor processing system may be used for a vehicle engine. The leakage determination device may determine leakage of fuel vapor during stopping of the vehicle engine. The first failure detecting function may be executed immediately after the vehicle engine is stopped.

In general, immediately after the engine start switch is switched off for stopping a vehicle (i.e., immediately after stopping the vehicle engine), the temperature of the fuel within the fuel tank may tend to increase due to the residual heat of the engine. This may cause increase in a pressure of fuel vapor that may be produced in the fuel tank. As a result, the pressure of the target region may also tend to increase. According to the above failure detection device, the controller may execute the first failure detection function without applying the pressure to the target region. In this way, the increase of pressure due to the residual heat may be effectively used for determination of leakage by the first failure detection function. Therefore, it is possible to save the power consumption resulting by the operation of the fuel pump.

In some cases, it may be possible that the increase of temperature of the fuel is not sufficient for increasing the pressure of fuel vapor to a value necessary for determining leakage. In such a case, the leakage determination by the first failure detecting function may be suspended. Then, the second failure detection function may determine whether or not leakage is occurring while the pressure applying device applies the pressure to the target region. Therefore, the determination of occurrence of leakage can be reliably performed. In addition, because the fuel pump is driven only when it is necessary to apply the pressure to the target region, the power consumption can be saved also in this respect.

The failure detecting device may further include a fuel temperature detecting device configured to detect a temperature of a fuel stored in the fuel tank. The first failure detecting function may suspend the determination of leakage if a change of the temperature of the fuel per unit time is smaller than a predetermined value.

If the change of the temperature of the fuel per unit time is larger than the predetermined value, this may mean that the pressure within the fuel tank is unstable. In such a case, the pressure of the target region may be unstable even if a pressure is applied by the pressure applying device. Therefore, it is difficult to distinguish whether the pressure is changed due to leakage of the fuel vapor or the pressure is changed due to change of the temperature of the fuel. For this reason, the determination of leakage may not be properly performed. By executing the second failure detecting function in the case that the change of the temperature of the fuel per unit time is smaller than the predetermined value, the determination of leakage may be properly performed by the second failure detection function.

The leakage determination device may terminate the determination of leakage when a fuel is refueled into the fuel tank during execution of the first failure detecting function or the second failure detecting function. When the fuel is refueled into the fuel tank, it may be possible that the pressure within the target region including the fuel tank abruptly increases. In such a case, the leakage determination may not be correctly made. Therefore, by stopping the leakage determination during refueling, it may be possible to further save the power consumption. In addition, because the leakage determination is made while the target region is closed, no damage to the fuel tank may occur.

Embodiments will now be described with reference to the drawings. It should be noted that the present invention may not be limited to the embodiments and may be applied to any other fuel vapor processing systems as long as they have a basic structure including a fuel tank and a canister. It may be possible to include various additional components, such as a heater for heating the canister, a separation membrane that can separate and refine fuel vapor, a suction device such as a vacuum pump that applies a negative pressure to the canister for positively desorbing fuel vapor from canister. In addition, the fuel vapor processing system may be suitably applied to vehicles such as automobiles that run on highly volatile fuel such as gasoline.

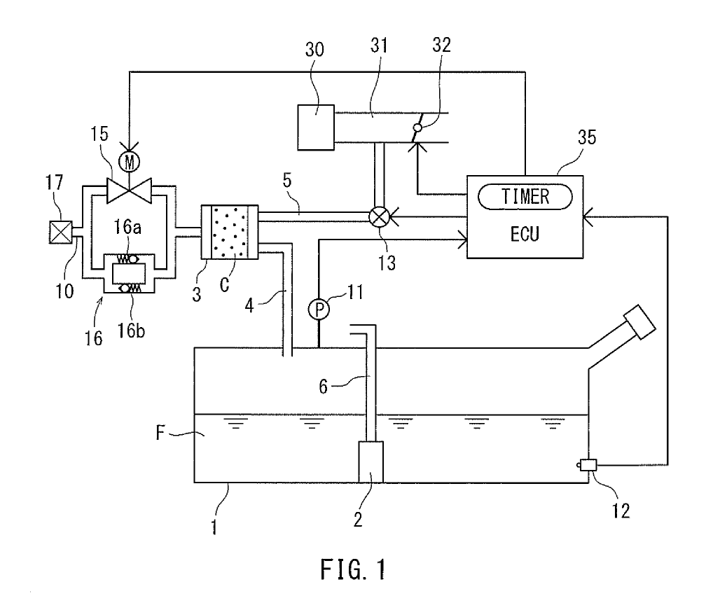

A first embodiment will be described in connection with a failure detection device that may be used for a fuel vapor processing system incorporating an evaporation purge system utilizing an intake air of an engine. Referring to FIG. 1, the fuel vapor processing system may include a fuel tank 1 storing fuel F, a fuel pump 2 for supplying the fuel F from within the fuel tank 1 to an internal combustion engine (herein after simply called an engine) 30, and a canister 3 for adsorbing fuel vapor that may be produced within the fuel tank 1. Reference numeral 31 designates an intake passage for supplying air to the engine 30. Reference numeral 32 designates a throttle valve that can control the amount of the intake air according to a stepping amount of an accelerator pedal (not shown). A vapor passage 4 may connect the fuel tank 1 and the canister 3. A purge passage 5 may connect the canister 3 and the intake passage 31. The purge passage 5 may be connected to the intake passage 31 at a position on a downstream side of the throttle valve 32. One end of the intake passage 31 opposite the engine 30 may be opened to the atmosphere via an air filter (not shown). The fuel pump 2 may be disposed within the fuel tank 1 and may pressurize and feed the fuel F to the engine 30 via a fuel delivery passage 6. An atmospheric passage 10 may have one end connected to the canister 3 and have an opposite end opened to the atmosphere.

A pressure sensor 11 may be disposed at the fuel tank 1 for detecting an internal pressure of a target region of the fuel vapor processing system including the fuel tank 1. The internal pressure of the target region will be hereinafter also called a “system pressure.” The pressure sensor 11 may be located at any position as long as it can detect the system pressure. For example, the pressure sensor 11 may be disposed at the canister 3, the vapor passage 4, or the purge passage 5 other than at the fuel tank 1. A fuel temperature sensor 12 may be disposed at the fuel tank 1 for detecting the temperature of the fuel F. Detection signals outputted from the pressure sensor 11 and the fuel temperature sensor 12 may be inputted to an engine control unit (ECU) 35 that serves as a controller. The ECU 35 may include a central processing unit (CPU), a read-only memory (ROM), a random access memory (RAM), etc. As will be explained later, the ROM may store a predetermined control program and a timer function. According to the predetermined control program, the CPU may control various components of the system at predetermined timings and may perform various processing operations.

Adsorbent C may be filled within the canister 3. The adsorbent C may be activated carbon that can allow passage of air while it can adsorb and desorb fuel vapor. A canister closed valve (CCV) 15 may be provided in the atmospheric passage 10 and may be operable to open and close the atmospheric passage 10. A purge passage valve 13 may be provided in the purge passage 5 and may be operable to open and close the purge passage 5. The CCV 15 and the purge passage valve 13 may serve as a closing device that can operate to open the target region to the atmosphere and to close the target region for interrupting communication of the target region with the atmosphere. More specifically, the CCV 15 may serve as a first closing device, and the purge passage valve 13 may serve as a second closing device. Thus, the target region may be a series of communication spaces extending from within the fuel tank 1 to the purge passage valve 13 and to the CCV 15. In other words, the determination of failure may be made to components including the fuel tank 1, the canister 3, the vapor passage 4, the purge passage 5 and the atmospheric passage 10. A positive and negative pressure relief valve device 16 may be provided in the atmospheric passage 10 in parallel to the CCV 15.

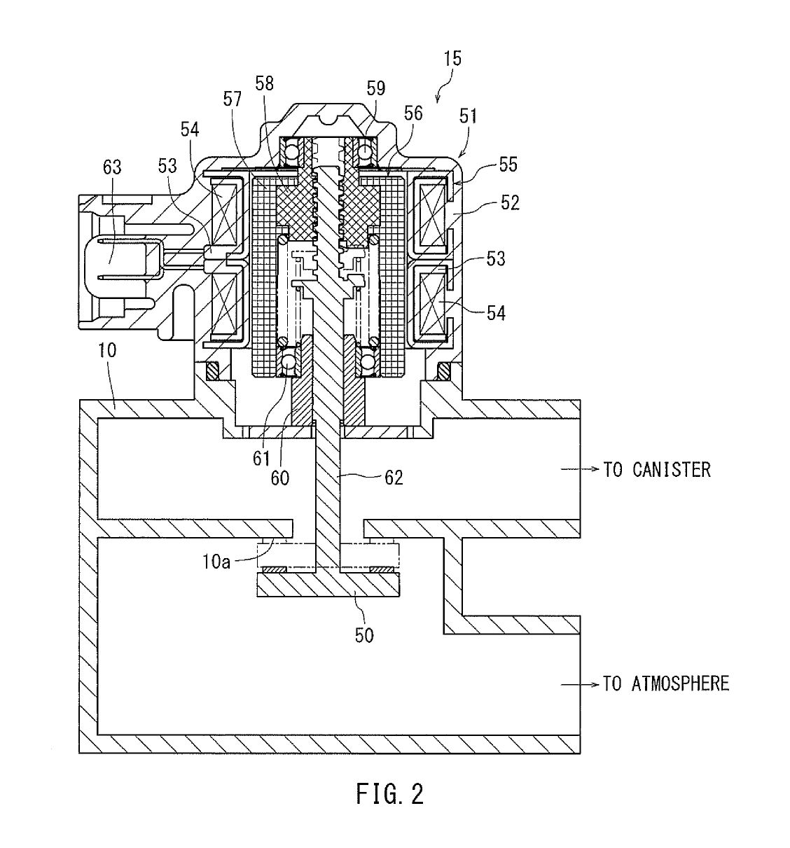

The ECU 35 may control opening and closing timings of the CCV 15. In this embodiment, the CCV 15 may be a step motor valve to which an electric power is applied only when switching between an open position and a closed position, while the valve is held at the open position or the closed position when no electric power is applied to the valve. More specifically, as shown in FIG. 2, the CCV 15 may include a valve member 50 that is moved to open and close by a step motor (also called as a stepper motor or a stepping motor) 51. The step motor 51 may have a motor housing 52 having a lower opening that communicates with the atmospheric passage 10. A stator 55 may be disposed within the motor housing 52 and may include a bobbin 53 and an exciting coil 54 wound around the bobbin 53. A rotor 56 may rotate within the stator 55 and may have a hollow cylindrical tubular shape. The rotor 56 may be supported by the motor housing 52 at a predetermined level so as to be rotatable about a vertical axis. Permanent magnets 57 may be attached to the outer circumference of the rotor 56. A nut member 58 may be disposed within the upper portion of the rotor 56 so as to be coaxially integrated therewith. The motor housing 52 may rotatably support the upper end portion of the nut member 58 via a bearing 59. A tubular bearing support 60 may be fixedly attached to a wall portion of the atmospheric passage 10 so as to be coaxial with the rotor 56. The upper portion of the bearing support 60 may rotatably support the lower end portion of the rotor 56 via a bearing 61.

An actuation shaft 62 may have an upper portion that is provided with a male thread engaging a female thread of the nut member 58. The actuation shaft 62 may serve as an output shaft of the step motor 51. The lower portion of the actuation shaft 62 may be supported by the bearing support 60 such that the actuation shaft 62 is prevented from rotation about its axis relative to the bearing support 60 while the actuation shaft 62 can move vertically in the axial direction. Therefore, as the rotor 56 rotates in a normal direction and a reverse direction, the actuation shaft 62 moves upward and downward in the axial direction. The lower end portion of the actuation shaft 62 may extend through the wall portion of the atmospheric passage 10. The valve member 50 may be formed integrally with the lower end portion of the actuation shaft 62 and may have a circular disk-shape that is coaxial with the actuation shaft 62. A valve seat 10a may be formed within the atmospheric passage 10. As the valve member 50 moves downward, the atmospheric passage 10 may be brought to an open state (communicating state) as indicated by solid lines in FIG. 2. On the other hand, as the valve member 50 moves upward to contact with the valve seat 10a, the atmospheric passage 10 may be brought to a closed state (communication interruption state) as indicated by chain lines (i.e., broken lines) in FIG. 2. The electric power may be applied to the step motor 51 via a terminal 63.

In order to change the closed state indicated by chain lines in FIG. 2 to the open state indicated by the solid lines, the ECU 35 may output a normal rotation signal to the step motor 51, so that the rotor 56 rotates in the normal direction to move the valve member 50 away from the valve seat 10a. In this way, the CCV 15 may be opened to bring the atmospheric passage 10 to the communication state. The application of electric power to the step motor 51 may be stopped at the time when the CCV 15 has been opened. Then, the valve member 50 may be held at the open position due to the thread engagement between the actuation shaft 62 and the nut member 58. In this way, the CCV 15 may be held at the open position after stopping the supply of electric power.

On the other hand, in order to switch the open state indicated by solid lines in FIG. 2 to the closed state indicated by the chain lines, the ECU 35 may output a reverse rotation signal to the step motor 51, so that the rotor 56 rotates in the reverse direction to move the valve member 50 to contact the valve seat 10a. In this way, the CCV 15 may be closed to bring the atmospheric passage 10 to the communication interruption state. Also in this case, after stopping the supply of electric power to the CCV 15, the valve member 50 may be held at the closed position due to the thread engagement between the actuation shaft 62 and the nut member 58. In this way, the CCV 15 may be held at the closed position.

The purge passage valve 13 may be an electromagnetic valve of a normally closed type, the opening and closing timings of which may be controlled by the ECU 35. A step motor type electromagnetic valve similar to the CCV 15 may be used as the purge passage valve 13. The relief valve device 16 may serve as a check valve for adjusting the pressure within the target region. As shown in FIG. 1, the relief valve device 16 may include a positive pressure relief valve 16a and a negative pressure relief valve 16b. The positive pressure relief valve 16a may be normally urged by a spring in a direction toward the side of the target region. The negative pressure relief valve 16b may be normally urged by a spring in a direction toward the side of the atmosphere. In this way, the positive and negative pressure relief valves 16a and 16b are configured as mechanical valves (spring type valves). When the system pressure (i.e., the pressure within the target region) exceeds a positive pressure limit, the positive pressure vale 16a may be opened against the urging force of the corresponding spring, so that an excessive positive pressure can be relieved. On the other hand, when the system pressure falls below a negative pressure limit, the negative pressure vale 16b may be opened against the urging force of the corresponding spring, so that an excessive negative pressure can be relieved. The positive pressure limit and the negative pressure limit can be adjusted by changing the urging forces applied by the springs.

The operation of the fuel vapor processing system configured as described above will be hereinafter described. During stopping of the vehicle (e.g. the state where an engine start key is switched off for stopping the engine), the CCV 15 may be opened, while the purge passage valve 13 may be closed. If the internal pressure of the fuel tank 1 has increased due to the residual heat of the engine after stopping the vehicle (e.g., parking of the vehicle) or due to refueling of fuel into the fuel tank 1, a gas (a mixture of air and fuel vapor produced within the fuel tank 1) may flow into the canister 3 via the vapor passage 4. Then, the fuel vapor may be selectively adsorbed and retained by the adsorbent C of the canister 3. The remaining part (air) of the gas passing through the adsorbent C may flow from the canister 3 to the atmospheric passage 10 so as to be dissipated to the atmosphere. In this way, the pressure within the fuel tank 1 can be relieved without causing atmosphere pollution. As a result, it is possible to prevent potential damage to the fuel tank 1.

On the other hand, during running of the vehicle, the ECU 35 may open the purge passage valve 13 while the CCV 15 is opened. Then, an intake negative pressure of the engine 30 may be applied to the canister 3 via the purge passage 5. Therefore, fuel vapor adsorbed by the adsorbent C of the canister 3 may be desorbed and may be thereafter purged into the intake passage 31 via the purge passage 5. At that time, the atmospheric air may be introduced from the atmospheric passage 10 into the canister 3 to promote desorption of fuel vapor.

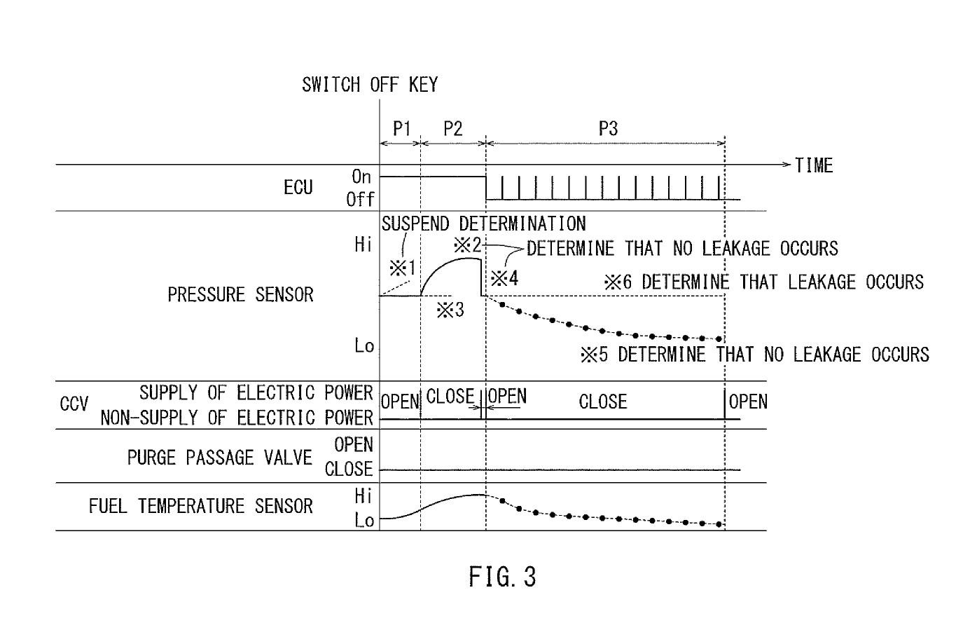

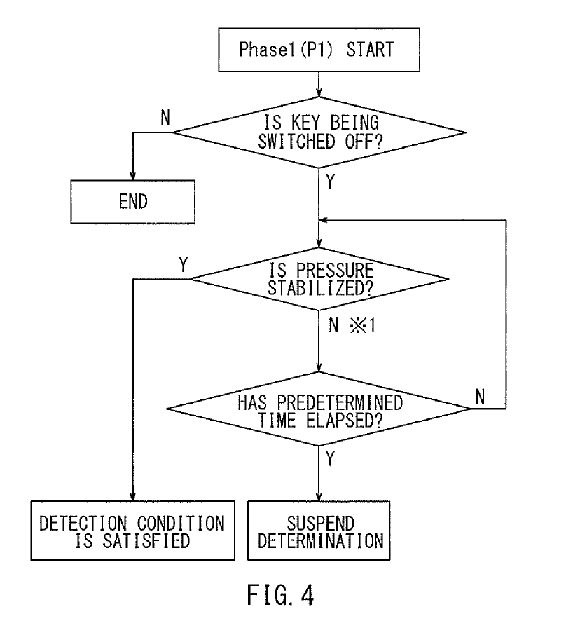

A failure determining process (i.e., a leakage detection process) for the fuel vapor processing system will now be described with reference to FIGS. 3 to 6. In FIGS. 4 to 6 that show various flowcharts, the symbol “Y” means “YES”, and the symbol “N” means “NO.” In general, the determination of leakage from the target region may be performed by closing the target region, detecting the internal pressure of the target region by the pressure sensor 11, and determining whether or not the detected pressure satisfies a predetermined criteria by the ECU 35. For this purpose, the determination of leakage may be preformed at the time when the target region is allowed to be closed (i.e., when the engine start key is being switched off for stopping the vehicle).

First, determination is made as to whether or not a failure detection condition for determining leakage is satisfied. More specifically, as indicated as Phase 1 (hereinafter also called a “failure detection condition determination phase P1”) in FIGS. 3 and 4, when the engine start key is switched off for stopping the vehicle, the purge passage valve 13 may be closed, while the CCV 15 may be opened under the control of the ECU 35. In this state, the target region is still opened to the atmosphere (non-sealed state), and the pressure within the target region may be basically kept in stable. Therefore, if the pressure within the target region (system pressure) is in stable, it may be determined that the failure detection condition is satisfied. Then, the process for determining leakage may be started. However, even in the case that the target region is opened to the atmosphere, it may be possible that the pressure is not kept in stable, for example, due to some influence, such as an abrupt change in a fuel temperature. In such a case, it may not be possible to correctly determine whether or not leakage is occurring. For this reason, according to this embodiment, the determination of leakage may be suspended unless the system pressure has become stable and unless the system pressure is kept to be stable during a predetermined time. This may avoid unnecessary power consumption.

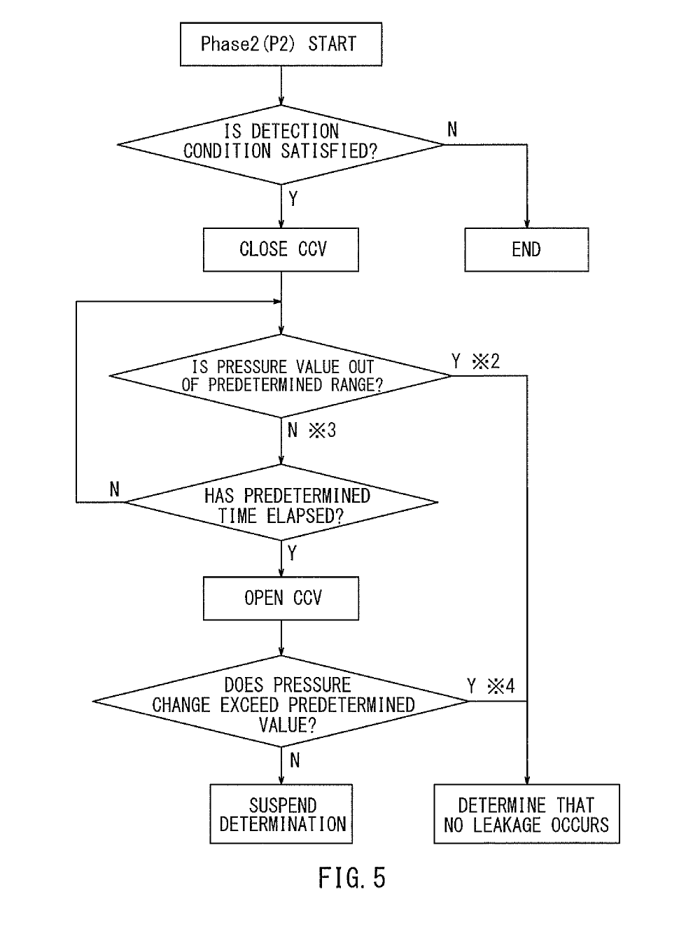

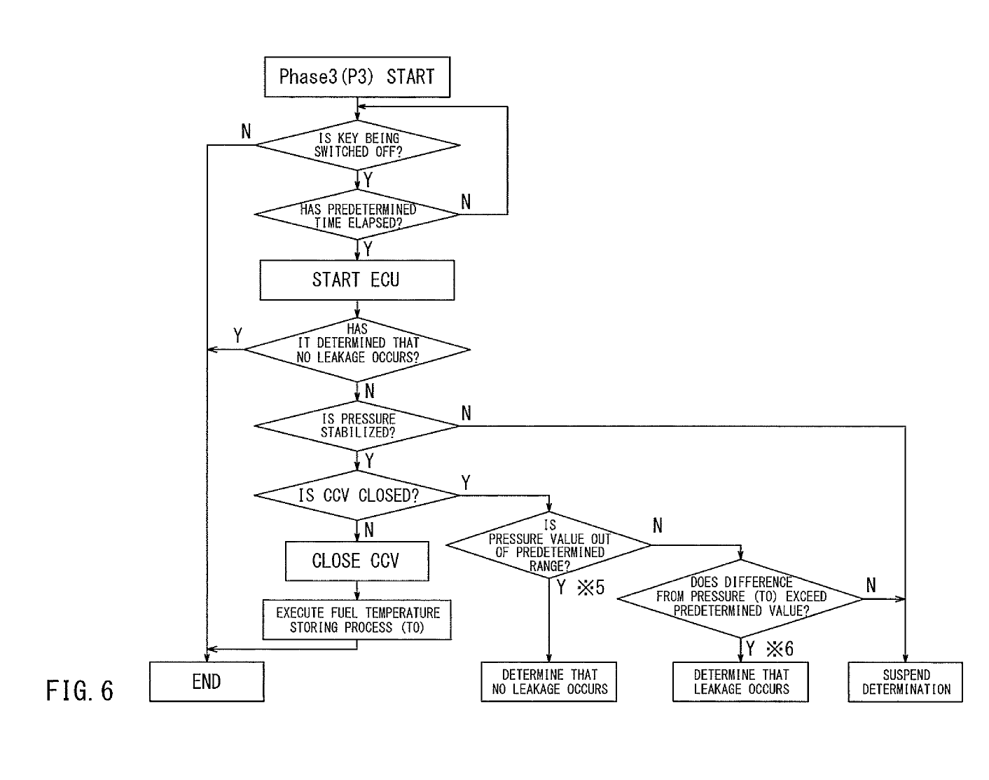

If it is determined that the failure detection condition is satisfied in the failure detection condition determination phase P1, the process may proceed to Phase 2 (hereinafter also called a “pre-determination phase P2”) shown in FIGS. 3 and 5 before proceeding to Phase P3 (hereinafter also called a “leakage determination phase P3) shown in FIGS. 3 and 6. In the pre-determination phase P2, the CCV 15 may be closed in order to close the target region. For this purpose, an electric power may be supplied to the CCV 15 only for switching the CCV 15 from the open state to the closed state. No electric power may be supplied to the CCV 15 after the CCV 15 has been closed, because the CCV 15 may be kept in the closed state when no electric power is supplied. At the time immediately after the engine start key is switched off for stopping the vehicle, the temperature of the fuel F may be increased due to the residual heat of the engine. Therefore, if the CCV 15 is closed at that time to close the target region, the pressure within the target region may be increased. Hence, if the pressure within the target region is out of a predetermined pressure range or exceeds a predetermined reference pressure, determination may be made that no leakage is occurring. The predetermined pressure range or the predetermined reference pressure may be previously set by the ECU 35. Although the predetermined pressure range may not be limited to a particular range, approximately ±1 KPa with reference to the atmospheric pressure may be preferable. If the predetermined pressure range is set to be considerably different from the atmospheric pressure, the leakage may not be correctly determined. If the determination is made that no leakage is occurring, the CCV 15 may be opened to bring the target region in to the open state to the atmosphere (non-closed state), and no leakage determination may be made after that. Also in this case, the electric power may be supplied to the CCV 15 only for switching the CCV 15 from the closed state to the open state. No electric power may be supplied to the CCV after the CCV 15 is opened because the CCV 15 is kept in the open state while no electric power is supplied to the CCV 15. The same can be applied to the opening and closing operations of the CCV 15 performed after that.

On the other hand, if the pressure within the target region is within the predetermined pressure range or does not exceed the predetermined reference pressure, the leakage determination may be temporarily suspended. In such a case, if the amount of heat from the engine is small, it may take much time to increase the pressure. However, if the pressure of the target region is still within the predetermined pressure range after a predetermined time has elapsed, the CCV 15 may be once opened to relieve the system pressure to the atmosphere, and thereafter, the CCV 15 may be closed to reset the system pressure to the atmospheric pressure. If the change in the system pressure caused by this operation exceeds a predetermined value that may be previously set to the ECU 35, it may be determined that no leakage is occurring. However, if the change does not exceed the predetermined value, the determination of leakage may be suspended.

If the determination of leakage is suspended in the pre-determination phase P2, the process proceeds to Phase 3 that is a full-fledged leakage determination phase and is indicated as P3 in FIG. 3 (hereinafter called “leakage determination phase P3”). However, a long-time and continuous determination of leakage may lead to increase of power consumption. For this reason, as shown in FIG. 1, the ECU 35 may have a timer function, which allows a periodical leakage determination, whereby a leakage determination circuit of the ECU 35 may be periodically operated by a predetermined time and the operation of the leakage determination circuit may be stopped at each time the leakage determination operation is finished. The period and the number of times of the periodical leakage determination may not be limited to a particular time and particular number of times. However, preferably, the leakage determination may be made by 5 to 15 times during a period of about 10 to 30 seconds after each 10 to 30 minutes. Even though the leakage determination is made by a relatively long period of time in this way, the necessary amount of electricity for each time of determination is relatively small. Therefore, the leakage determination can be made with high accuracy and with reduced power consumption.

During the leakage determination phase P3, the system pressure may decrease as the temperature of the fuel F decreases as shown in FIG. 3 because the target region has been once opened to the atmosphere in the pre-determination phase P2. The temperature of the fuel F may change with the change of the temperature of the atmosphere to cause a change in the system pressure. In the leakage determination phase P3, as shown in FIG. 6, the leakage determination circuit of the ECU 35 may start to operate after a predetermined time has elapsed from switching off the engine start key. However, if it has been already determined that no leakage is occurring in the pre-determination phase P2, no determination step will follow and the operation of the leakage determination circuit may be stopped. Naturally, the leakage determination may not be performed if the engine start key is being switched on. In the case that the leakage determination is suspended in the pre-determination phase P2, the leakage determination is made on the condition that the CCV 15 is closed and that the system pressure is in stable. If the system pressure is not in stable, the leakage determination may be suspended. If the system pressure is in stable, it may be determined whether or not the CCV 15 is closed. If the CCV 15 is opened, the ECU 35 may close the CCV 15. The process then proceeds to a fuel temperature store process (T0), in which the ECU 35 may calculate an estimated pressure of the closed target region at the temperature of the fuel F detected by the fuel temperature sensor 12 at that time. To this end, the ECU 35 may previously store a data of a characteristic curve showing the relationship between the fuel temperature and the pressure of the closed target region.

As described previously, it may be determined that no leakage is occurring if the pressure of the target region (system pressure) is out of the predetermined pressure range set to the ECU 35. In many cases, a value of the system pressure determined to be out of the predetermined pressure range may be lower than a minimum value of the predetermined pressure range or may be lower than the reference pressure, because the system pressure may tend to decrease during the leakage determination. However, in some cases, the system pressure may increase, for example, due to increase of the temperature of the atmosphere. In such a case, the pressure may become higher than a maximum value of the predetermined pressure range or the reference pressure. On the other hand, if the system pressure is within the predetermined pressure range, the detected pressure (actual pressure) may be compared with the estimated pressure of the closed target region calculated in the fuel temperature store process (T0). If a difference between the actual pressure and the estimated pressure exceeds a predetermined value, it may be determined that leakage is occurring. If it has been determined in the leakage determination phase P3 that leakage is occurring or no leakage is occurring, no further determination stem will follow. On the other hand, if the difference between the actual pressure and the estimated pressure does not exceed the predetermined value, the determination may be suspended, and the process may proceed to the next leakage determination routine. The leakage determination phase P3 may be periodically performed by the number of times set to the timer of the ECU 35.

Incidentally, if it is detected that the fuel is being refueled during the determination of the leakage including that performed in the pre-determination phase P2, the ECU 35 may stop the determination process. For this purpose, a suitable sensor may be disposed at the fuel tank 1 for detecting refueling and outputting a detection signal to the ECU 35.

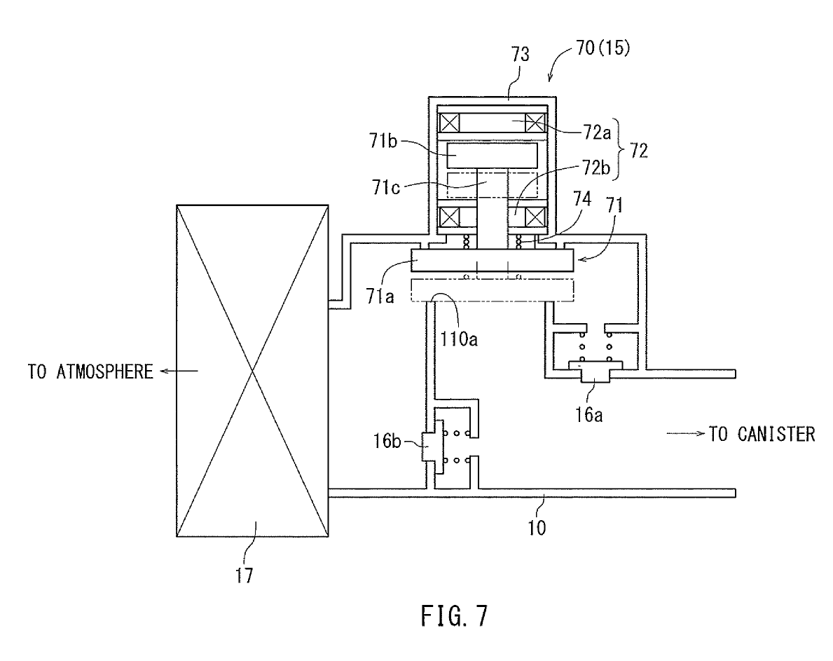

The above embodiment described above may be modified in various ways. For example, in the above embodiment, a step motor type valve is used as the CCV 15 that may be switched between the open position and the closed poison upon receiving the supply of the electric power and may be kept in either the open position or the close position when receiving no electric power. However, it may be possible to use any other valves, such as an electromagnetic valve with a magnet, or a valve including a DC motor and a reduction gear, for the CCV 15. The electromagnetic valve with a magnet may be called an electromagnetic lock. Referring to FIG. 7, an electromagnetic valve with a magnet is designated by reference numeral 70 and may include a valve member 71 and an electromagnet 72 that can move the valve member 71 between an open position indicated by solid lines in FIG. 7 and a closed position indicated by chain lines. More specifically, a housing 73 made of magnetic material such as iron may be connected to the atmospheric passage 10. An upper electromagnet 72a and a lower electromagnet 72b may be respectively mounted within the upper end portion and the lower end portion of the housing 72. The valve member 71 may include a valve portion 71a for contacting with a valve seat 110a formed in the atmospheric passage 10, an actuation portion 71b vertically movable between the upper electromagnet 72a and the lower electromagnet 72b, and a connecting portion 71c connecting between the valve portion 71a and the actuation portion 71b. The actuation portion 71b may be made of magnetic material, while the valve portion 71a may be made of non-magnetic material. The connecting portion 71c may extend through the lower electromagnet 72b. A compression spring 74 may normally urge the valve portion 71 toward the open position.

In the case of the electromagnetic valve 70 shown in FIG. 7, in order to move the valve portion 71a from the open position indicated by solid lines to the closed position indicated by chain lines, an electric power may be supplied to the lower electromagnet 72b to generate a magnetic field, so that the actuation portion 71b may be attracted to the electromagnet 72b. In this way, the valve member 71 may be closed. After the valve member 71 is closed, the supply of electric power to the electromagnet 72b may be stopped. However, because the actuation portion 71b and the housing 73 are magnetized, the valve member 71 may be kept at the closed position even after the supply of electric power to the electromagnet 72b is stopped. The compression spring 74 may help to ensure close contact of the valve portion 71a with the valve seat 110a.

In order to move the valve portion 71a from the closed position to the open position, an electric power may be supplied to the upper electromagnet 72a to generate a magnetic field, so that the actuation portion 71b may be attracted to the electromagnet 72a against the urging force of the compression spring 74. In this way, the valve member 71 may be opened. After the valve member 71 is opened, the supply of electric power to the electromagnet 72a may be stopped. However, because the actuation portion 71b and the housing 73 are magnetized, the valve member 71 may be kept at the open position even after the supply of electric power to the electromagnet 72a is stopped.

In the case of the embodiment shown in FIG. 1, the positive and negative pressure relief valve device 16 including the positive pressure relief valve 16a and the negative pressure relief valve 16b is arranged in parallel to the CCV 15 by providing two separate branched passages in the atmospheric passage 10. On the other hand, in the case of the arrangement shown in FIG. 7, the positive pressure relief valve 16a and the negative pressure relief valve 16b are assembled within the atmospheric passage 10 together with the CCV 15 (the electromagnetic valve 70). Also in this arrangement, the CCV 15 is practically parallel to the positive and negative pressure relief valve device 16.

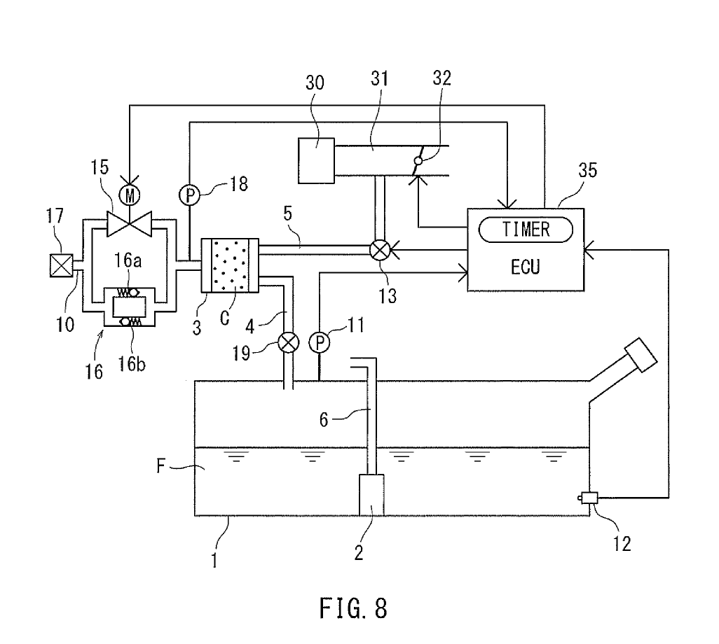

In the case of the above embodiments, the determination of leakage from the target system is made by using only one pressure sensor 11 both for the side of the fuel tank 1 and the side of the canister 3. However, it may be possible to perform determination of leakage separately on the side of the fuel tank 1 and on the side of the canister 3 as shown in FIG. 8. In the arrangement shown in FIG. 8, a canister internal pressure sensor 18 may be provided for detecting the internal pressure of the canister 3 in addition to the pressure sensor 11 that serves as a fuel tank internal pressure sensor for detecting the pressure within the fuel tank 1. In this connection, a vapor passage valve 19 may be provided in the vapor passage 4 connecting between the fuel tank 1 and the canister 3. The vapor passage valve 19 may serve as a shut-off valve that can be opened to allow communication between the fuel tank 1 and the canister 3 and can be closed to interrupt communication between the fuel tank 1 and the canister 3. Therefore, when the leakage is to be determined, the vapor passage valve 19 may be closed to interrupt communication between the fuel tank 1 and the canister 3, so that determination of leakage can be performed separately on the side of the fuel tank 1, i.e., a part on the side of the fuel tank 1 of the target region, and on the side of the canister 3, i.e., a part on the side of the canister 3 of the target region. The vapor passage valve 19 may be operated to open simultaneously with opening the CCV 15, and the vapor passage valve 19 may be closed simultaneously with closing the CCV 15. Also in this case, the processes in Phases P1, P2 and P3 may be performed in a manner similar to the above embodiments. Similar to the purge passage valve 13, the vapor passage valve 19 may be an electromagnetic valve of a normally closed type, the opening and closing timings of which may be controlled by the ECU 35.

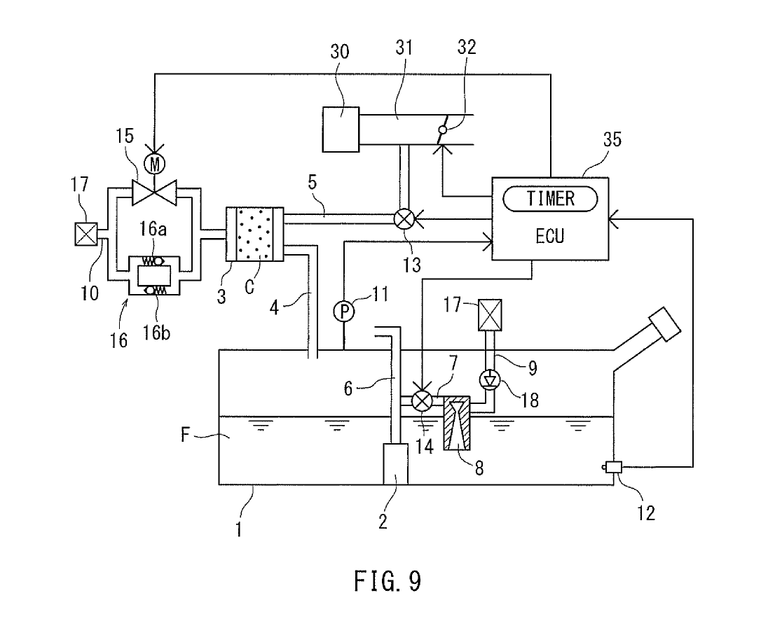

Another embodiment will now be described. Referring to FIG. 9, there is shown a fuel vapor processing system incorporating a failure detection device according to another embodiment. The fuel vapor processing system shown in FIG. 9 is a modification of the fuel vapor processing system shown in FIG. 1. Therefore, in FIG. 9, like members are given the same reference numerals as FIG. 1 and the description will be focused mainly to the elements that are different from the elements shown in FIG. 1.

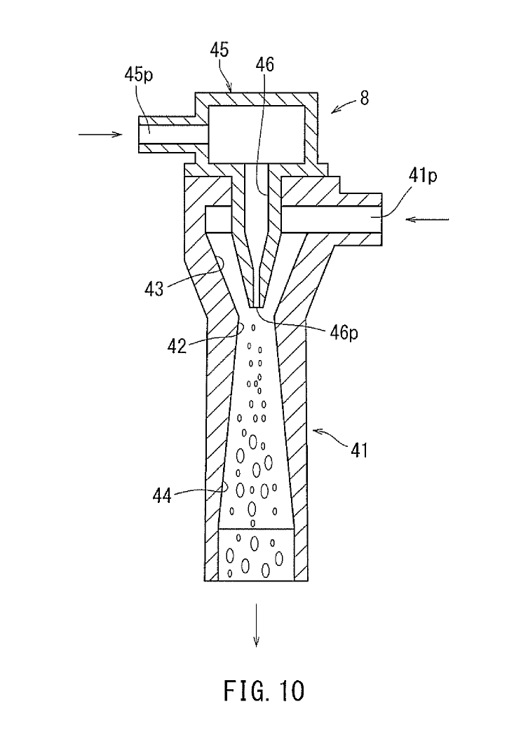

The fuel vapor processing system shown in FIG. 9 may include a branch passage 7. The branch passage 7 may be branched off from the fuel delivery passage 6 and may have one end connected thereto. A jet pump (aspirator) 8 may be connected to the other end of the branch passage 7. In this way, the jet pump 8 may be connected to the fuel pump 2 via the branch passage 7 and the fuel delivery passage 6. As shown in FIG. 10, the jet pump 8 may include a pressure reduction chamber 43. One end of a suction passage 9 (see FIG. 9) may be connected to the pressure reduction chamber 43 and the other end of the suction passage 9 may be opened to the atmosphere.

A fuel shut-off valve 14 may be provided in the branch passage 7 and may be opened for allowing introduction of the fuel F into the jet pump 8 and may be closed for preventing introduction of the fuel F into the jet pump 8. In another embodiment, the fuel shut-off valve 14 may be provided in the jet pump 8. For example, a needle valve (not shown) serving as a shut-off valve may be provided in a nozzle body 46 (see FIG. 10) of the jet pump 8 for controlling the fuel injection timing from the nozzle body 46.

As shown in FIG. 10, the jet pump 8 may include a venturi portion 41 and a nozzle portion having the nozzle body 46. The venturi portion 41 may include a throat 42, the pressure reduction chamber 43, a diffuser 44 and a suction port 41p. The pressure reduction chamber 43 may be disposed on an upstream side of the throat 42 with respect to a direction of flow of the fuel and may be tapered toward the throat 42. The diffuser 44 may be disposed on a downstream side of the throat 42 with respect to the direction of flow of the fuel and may be diverged in the downward direction. The pressure reduction chamber 43, the throat 42 and the diffuser 44 may be arranged so as to be coaxial with each other. The suction port 41p may be formed so as to communicate with the pressure reduction chamber 43. The suction passage 9 may be connected to the suction port 41p. The nozzle portion 45 may be connected to the upstream side part of the venturi portion 41 and may include an introduction port 45p and the nozzle body 46. The fuel may be introduced into the jet pump 8 via the introduction port 45p and may then be injected from the nozzle body 46. The nozzle body 46 may be coaxially inserted into the pressure reduction chamber 43 and may have an injection port 46p opened at the throat 42.

When the fuel shut-off valve 14 is opened, the fuel F injected from the fuel pump 2 may be introduced into the jet pump 8 via the fuel delivery passage 6, the branch passage 7 and the fuel introduction port 45p. Thereafter, the introduced fuel F may be injected from the nozzle body 46 to flow at a high speed in the axial direction through the throat 42 and the central region of the diffuser 44. Then, a negative pressure may be produced in the pressure reduction chamber 43 by a venturi effect. Therefore, a suction force may be produced in the suction port 41p and the suction passage 9, so that the atmospheric air may be drawn through the suction passage 9. The drawn air may be discharged from the diffuser portion 44 into the fuel tank 1 together with the fuel F injected from the nozzle body 46. As a result, a pressure may be applied to the target region of the system including the fuel tank 1. In this way, the jet pump 8 may serve to apply a positive pressure to the target region by utilizing the driving force of the fuel pump 2.

Similar to the purge passage valve 13, the fuel shut-off valve 14 may be an electromagnetic valve of a normally closed type, the opening and closing timings of which may be controlled by the ECU 35. Alternatively, a step motor valve similar to that of the CCV 15 may be used for the shut-off valve 14.

The operation of the fuel vapor processing system shown in FIG. 9 will be hereinafter described. During stopping of the vehicle (e.g. the state where an engine start key is switched off for stopping the engine), the CCV 15 may be opened, while the purge passage valve 13 and the fuel-shut-off valve 14 may be closed. Therefore, similar to the embodiment shown in FIG. 1, if the internal pressure of the fuel tank 1 has increased due to the residual heat of the engine after stopping the vehicle (parking of the vehicle) or due to refueling of fuel into the fuel tank 1, a gas (a mixture of air and fuel vapor produced within the fuel tank 1) may flow into the canister 3 via the vapor passage 4.

On the other hand, during running of the vehicle, the ECU 35 may open the purge passage valve 13 while the CCV 15 is opened and the fuel shut-off valve 14 is closed. Therefore, similar to the first embodiment, an intake negative pressure of the engine 30 may be applied to the canister 3 via the purge passage 5. Hence, fuel vapor adsorbed by the adsorbent C of the canister 3 may be desorbed and may be thereafter purged into the intake passage 31 via the purge passage 5.

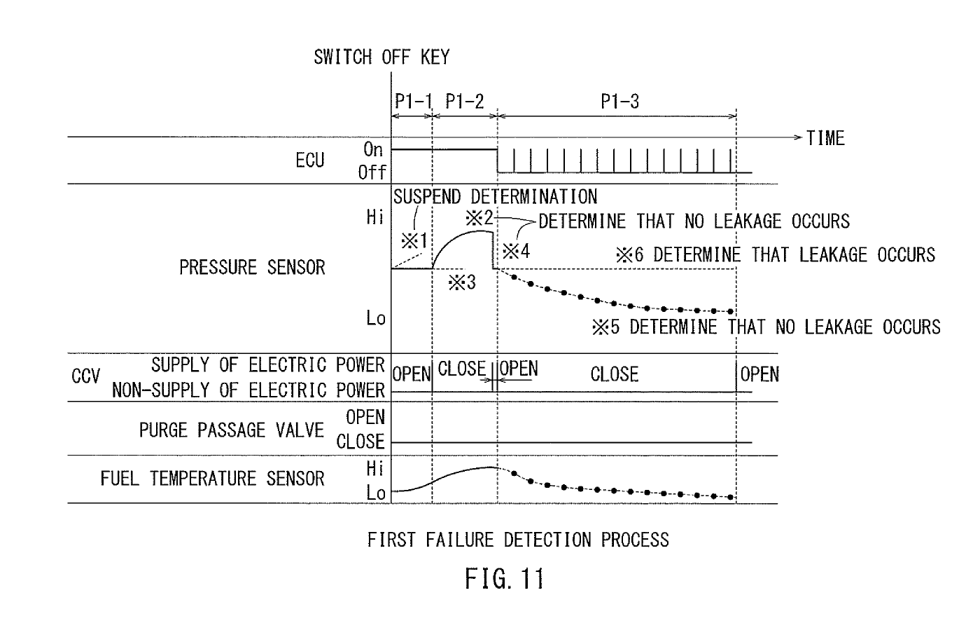

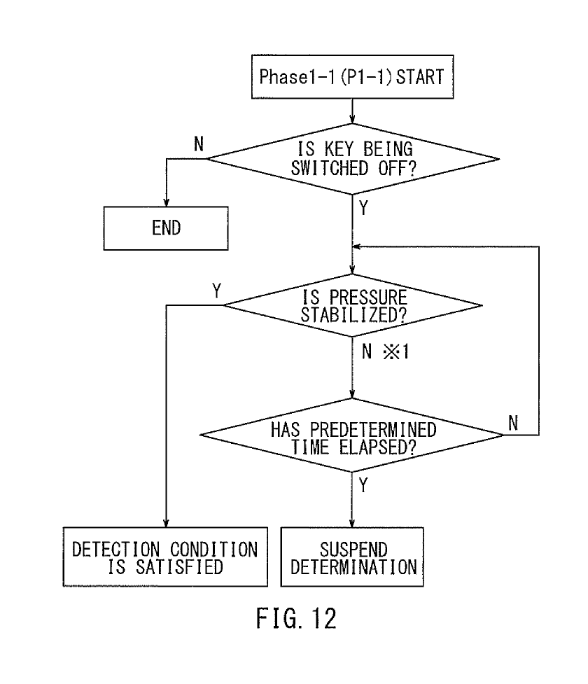

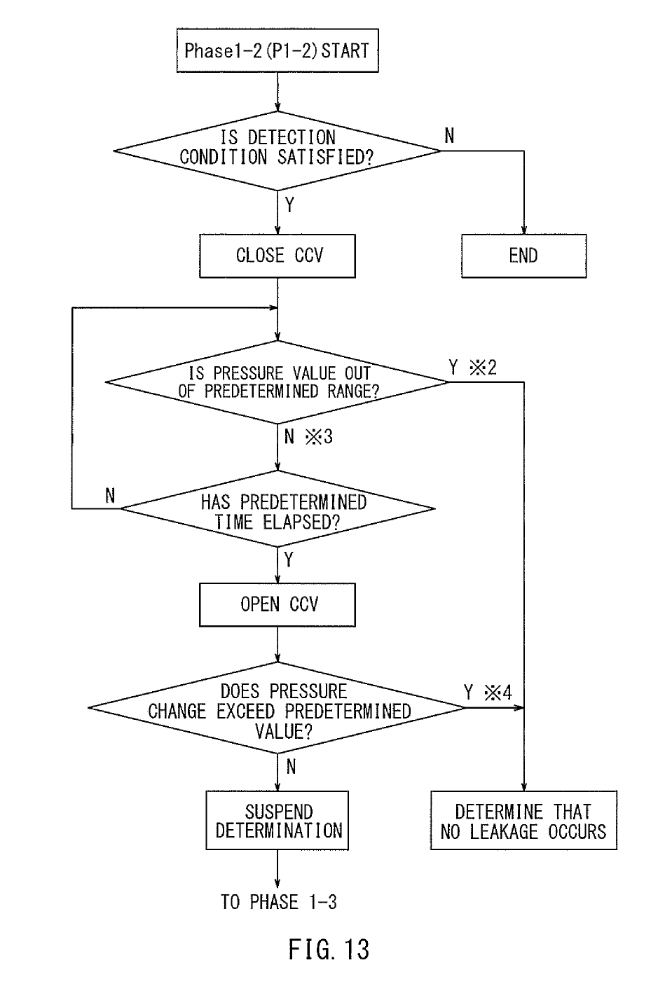

A failure determining process (leakage detection process) for the fuel vapor processing system shown in FIG. 9 will now be described with reference to FIGS. 11 to 18. In FIGS. 12 to 14 and 16 to 18 showing various flow charts, the symbol “Y” means “YES”, and the symbol “N” means “NO” as in the first embodiment. Also, similar to the first embodiment, the determination of leakage from the target region may be performed by closing the target region, detecting the internal pressure of the target region by the pressure sensor 11, and determining whether or not the detected pressure satisfies predetermined criteria by the ECU 35. Also in this embodiment, the determination of leakage may be preformed at the time when the target region is allowed to be closed, i.e., when the engine start key is being switched off for stopping the vehicle.

Initially, a first failure detection process may be performed based on a change in pressure that may be caused according to a change in temperature due to the residual heat of the engine without driving the fuel pump 2. After that, a second failure detection process may be performed while a pressure is applied to the target region by driving the fuel pump 2. In the first failure detection process, prior to the determination of leakage, determination is made as to whether or not a failure detection condition for determining leakage is satisfied as indicated as Phase 1-1 (hereinafter also called a “failure detection condition determination phase P1-1”) in FIGS. 11 and 12. The process performed in Phase 1-1 may be similar to the Phase 1 (P1) shown in FIG. 4. Thus, if the pressure within the target region (system pressure) is in stable, it may be determined that the failure detection condition is satisfied. Then, the process for determining leakage may be started. On the other hand, the determination of leakage may be suspended unless the system pressure has become stable and unless the system pressure is kept to be stable during a predetermined time.

If it is determined that the failure detection condition is satisfied in the failure detection condition determination phase P1-1, the process may proceed to a leakage determination phase. However, also in this embodiment, as indicated as Phase 1-2 (hereinafter also called a “pre-determination phase P1-2”), a pre-determination phase similar to the pre-determination phase P2 shown in FIG. 5 may be performed before proceeding to the leakage determination phase. The process performed in the pre-determination phase 1-2 may be basically the same as that performed in the pre-determination phase P2. Thus, in the pre-determination phase 1-2, the CCV 15 is closed to seal the target system. The purge passage valve 13 and the fuel shut-off valve 14 may be kept to be closed. If the pressure within the target system is out of a predetermined pressure range or exceeds a predetermined reference pressure, it may be determined that no leakage is occurring.

On the other hand, if the pressure of the target region is still within the predetermined pressure range after a predetermined time has elapsed, the CCV 15 may be once opened to relieve the system pressure to the atmosphere, and thereafter, the CCV 15 may be closed to reset the system pressure to the atmospheric pressure. If the change in the system pressure caused by this operation exceeds a predetermined value that may be previously set to the ECU 35, it may be determined that no leakage is occurring. If the change does not exceed the predetermined value, the determination of leakage may be suspended.

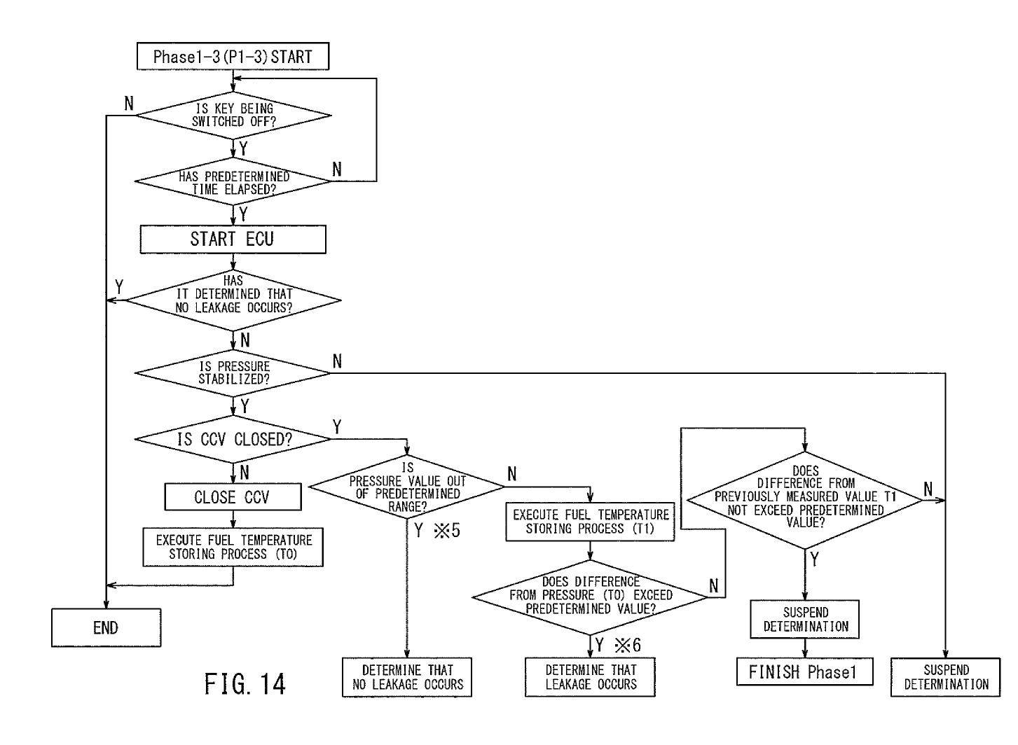

If the determination of leakage is suspended in the pre-determination phase P1-2, the process proceeds to a full-fledged leakage determination phase that is Phase 1-3 indicated as P1-3 in FIGS. 11 and 14 (hereinafter called “leakage determination phase P1-3”). Also, in this embodiment, due to the timer function of the ECU 35, a periodical and timed leakage determination similar to that performed in the leakage determination phase P3 shown in FIG. 6 may be performed.

Also, the leakage determination phase P1-3 may be basically the same as the leakage determination phase P3. Thus, in the case that the leakage determination is suspended in the pre-determination phase P1-2, the leakage determination is made on the condition that the CCV 15 is closed and that the system pressure is in stable. If the system pressure is not in stable, the leakage determination may be suspended, and the process proceeds to the next leakage determination routine. If the CCV 15 is opened, the ECU 35 may close the CCV 15, and the process may then proceed to the fuel temperature store process (T0).

As described previously, it may be determined that no leakage is occurring if the pressure of the target region (system pressure) is out of the predetermined pressure range set to the ECU 35. On the other hand, if the system pressure is within the predetermined pressure range, a next fuel temperature store process (T1) may be performed. The leakage determination phase P1-3 is different from the leakage determination phase P3 shown in FIG. 6 in the incorporation of the next fuel temperature store process (T1) and its subsequent steps. The fuel temperature store process (T1) may calculate an estimated pressure of the sealed system in a manner similar to the fuel temperature store process (T0). If it has been determined that leakage is occurring or that no leakage is occurring, no further determination process may be made. In the case that a difference between the actual pressure and the estimated pressure calculated by the fuel temperature store process (T0) does not exceed a predetermined value, the actual pressure may be compared with an estimated pressure calculated by the fuel temperature store process (T1). If a difference between the actual pressure and the estimated pressure calculated by the fuel temperature store process (T1) exceeds a predetermined value, the determination may be suspended until the first failure determination process is made at the next time. The leakage determination phase P1-3 may be repeatedly performed according to the timer function of the ECU 35. On the other hand, if the difference between the actual pressure and the estimated pressure calculated by the fuel temperature store process (T1) does not exceed the predetermined value, the determination may be suspended and the process may proceed to the second failure determination process.

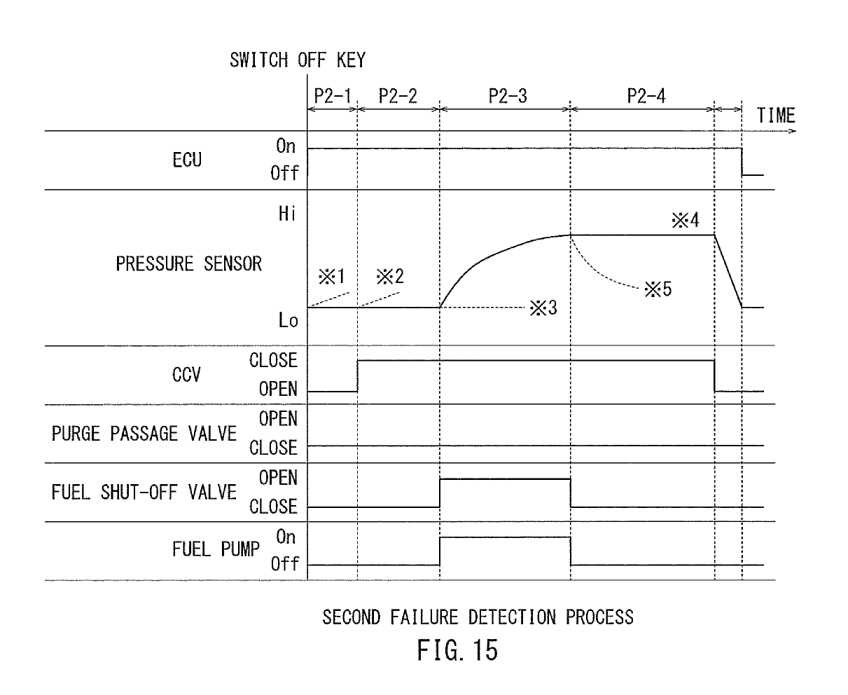

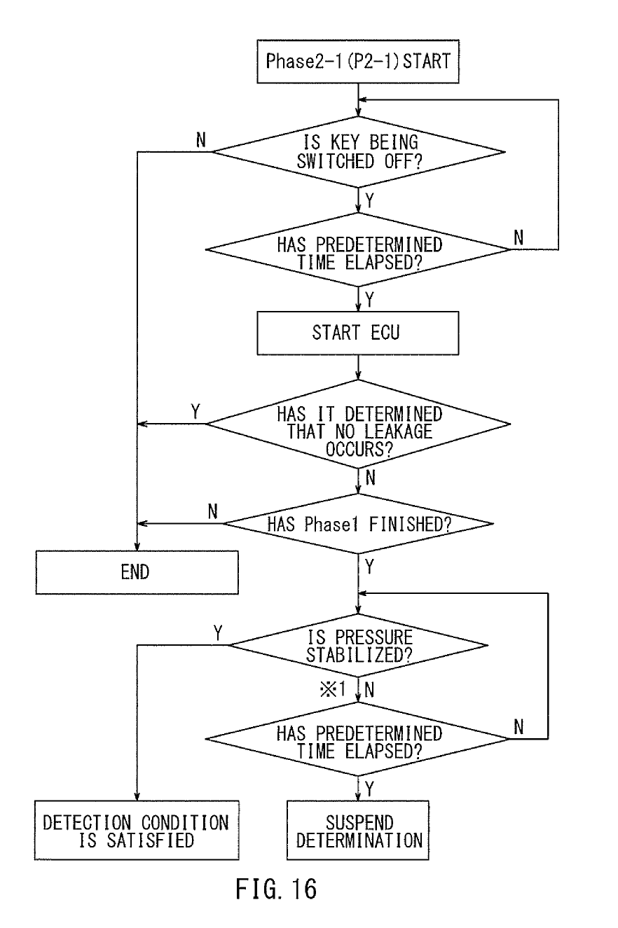

As shown in FIG. 15, in the second failure determination process, the pump 2 may be driven to positively apply a pressure to the target region during determination of leakage. To this end, it may be determined whether or not a failure detection condition is satisfied as in the case of the first failure determination process. More specifically, in Phase 2-1 (hereinafter also called “failure detection condition determination phase P2-1”) shown in FIGS. 15 and 16), if a predetermined time has elapsed after the engine start key is switched off in the state that the CCV 15 is opened to once reset the pressure of the target region (system pressure) to the atmospheric pressure, a second failure determination circuit of the ECU 35 may be started to operate. More specifically, if it is confirmed that Phase 1-1 has been finished, it may then be determined as to whether or not the system pressure is in stable. If the pressure is in stable, it may be determined that the failure detection condition is satisfied. On the other hand, if the system pressure is not in stable during a predetermined time, the determination of leakage may be suspended.

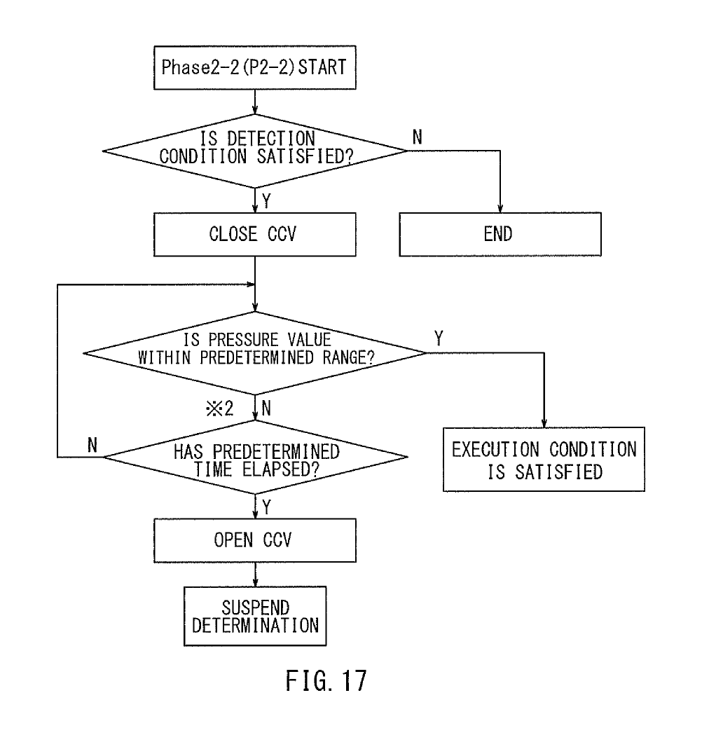

If the failure detection condition determination phase P2-1 determines that the detection condition is satisfied, the process proceeds to Phase 2-2 (hereinafter also called “execution condition determination phase P2-2) shown in FIGS. 15 and 17, in which it is determined whether or not the condition for executing the leakage determination is satisfied. In the execution condition determination phase P2-2, if the failure detection condition is confirmed to be satisfied, the CCV 15 may be closed to close the target region. After that, if the pressure within the target region (system pressure) is within a predetermined range, it may be determined that the execution condition is satisfied. If the system pressure is out of the predetermined range continuously during a predetermined time, the CCV 15 may be opened, and the determination of leakage may be suspended.

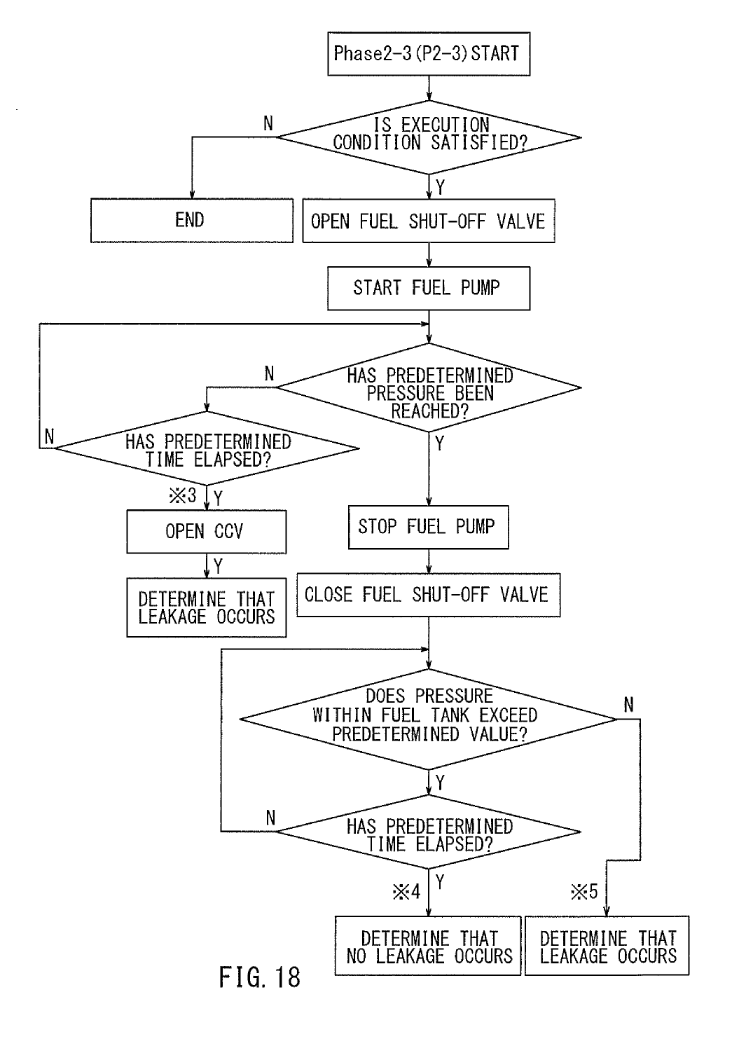

If the execution condition determination phase P2-2 determines that the execution condition is satisfied, the process proceeds to Phase 2-3 (hereinafter also called “leakage determination phase P2-3) shown in FIGS. 15 and 18, in which the leakage is determined while a pressure is applied to the target region. More specifically, as shown in FIGS. 15 and 18, the fuel shut-off valve 14 may be opened and the fuel pump 2 may then be driven. Therefore, the fuel F may be supplied from the fuel pump 2 to the jet pump 8 via the branch passage 7. This may cause that the atmospheric air may be drawn from the atmosphere into the jet pump 8 via the suction passage 9, so that a positive pressure may be applied to the target region. If the pressure within the target region (system pressure) does not reach a predetermined pressure even after a predetermined time has elapsed, it may be determined that leakage is occurring. On the other had, if the system pressure has reached the predetermined pressure, the fuel pump 2 may then be stopped, and the fuel shut-off valve 14 may be closed. After that, if the system pressure exceeds a predetermined pressure during a predetermined time, it may be determined that no leakage is occurring. If the system pressure does not continuously exceed the predetermined pressure during the predetermined time, for example, due to progressive reduction, it may be determined that leakage is occurring. The leakage determination process may then be finished

Also in this embodiment, the leakage determination may be forcibly stopped if refueling of fuel into the fuel tank 1 is detected during the first failure detection process or the second failure detection process.

Also in this embodiment, the CCV 15 may not be limited to a step motor valve and may be an electromagnetic valve with a magnet, or a valve including a DC motor and a reduction gear. The electromagnetic valve with a magnet may be that described in the first embodiment and shown in FIG. 7.

What is claimed is:

1. A failure detecting device for a fuel vapor processing system including a fuel tank and a canister, the failure detecting device comprising:
a pressure detecting device configured to detect a pressure within a target region of the fuel vapor processing system;
a closing device configured to close the target region; and
a leakage determination device configured to determine leakage of fuel vapor from the target region based on a change of pressure within the target region in a closed state of the target region; wherein:
the closing device comprises a canister closed valve provided in an atmospheric passage that connects the canister to an atmosphere; and
the canister closed valve is configured to switch between an open position and a closed position upon receiving a supply of electric power, and to maintain the open position or the closed position when no electric power is supplied to the canister closed valve.

2. The failure detecting device according to claim 1, further comprising a fuel temperature detecting device configured to detect a temperature of a fuel within the fuel tank, wherein the leakage determination device is configured to determine leakage of fuel vapor from the target region based on a change of temperature of the fuel in addition to the change of pressure within the target region.

3. The failure determining device according to claim 1, wherein:
the fuel vapor processing system is incorporated into a vehicle engine;
the leakage determination device includes a controller configured to control the canister closed value and to execute a timer function that performs a timed leakage determination process in which a leakage determination operation is periodically performed with a predetermined time even during stopping of the vehicle engine.

4. The failure determining device according to claim 3, wherein:
the controller is configured to execute a pre-determination function before executing the timer function,
the pre-determination function determines that no leakage occurs if the change of pressure within the target region within a predetermined time after closing the target region is out of a predetermined range, and
the pre-determination function suspends the determination of leakage if the change of pressure within the target region within the predetermined time after closing the target region is within the predetermined range.

5. The failure detecting device according to claim 4, wherein:
if the determination of leakage is suspended by the pre-determination function, the controller opens the canister closed valve to reset the pressure within the target region to an atmospheric pressure, closes the canister closed valve to bring the target region into the closed state, and thereafter performs the timed leakage determination process.

6. The failure detecting device according to claim 1, wherein the canister closed valve is driven by a step motor.

7. The failure detecting device according to claim 1, further comprising a mechanical positive and negative pressure relief valve provided in the atmospheric passage and arranged parallel to the canister closed valve, wherein the mechanical positive and negative pressure relief valve is configured to open both when the pressure within the target region exceeds a predetermined positive pressure and falls blow a predetermined negative pressure.

8. The failure detecting device according to claim 1, wherein the leakage determination device is configured to terminate determination of leakage when the fuel tank is being refueled.

9. The failure detecting device according to claim 1, wherein:
the pressure detecting device includes a first detecting device configured to detect a pressure within the fuel tank and a second detecting device configured to detect a pressure within the canister;
the failure detecting device further includes a shut-off device provided in a vapor passage connecting between the fuel tank and the canister, the shut-off device being configured to switch between an open position for allowing communication between the fuel tank and the canister and a closed position for interrupting communication between the fuel tank and the canister; and
when the leakage is to be determined, the shut-off device is switched to the closed position, so that the determination of leakage is performed separately for each of a first part of the target region on the side of the fuel tank and a second part of the target region on the side of the canister.

10. A failure detecting device for a fuel vapor processing system including a fuel tank, a canister and a fuel pump, the failure detecting device comprising:
a pressure detecting device configured to detect a pressure within a target region of the fuel vapor processing system;
a closing device configured to close the target region; and
a pressure applying device driven by the fuel pump and configured to apply a pressure to the target region;
a leakage determination device configured to determine leakage of fuel vapor from the target region based on a change of a pressure within the target region in a closed state of the target region; wherein:
the leakage determination device has a first failure detection function and a second failure detection function;
the first failure detection function determines whether or not leakage occurs based on a change of the pressure within the target region without applying the pressure to the target region by the pressure applying device;
the second failure detection function determines whether or not leakage occurs based on the change of the pressure within the target region after the pressure applying device applies the pressure to the target region; and
the leakage determination device is configured to execute the second failure detection function only when the determination by the first failure detecting function is suspended.

11. The failure detecting device according to claim 10, wherein:
the fuel vapor processing system is incorporated into a vehicle engine;
the leakage determination device is configured to determine leakage of fuel vapor during stopping of the vehicle engine; and
the first failure detecting function is executed immediately after the vehicle engine is stopped.

12. The failure detecting device according to claim 10, further comprising a fuel temperature detecting device configured to detect a temperature of a fuel stored in the fuel tank; wherein:
the first failure detecting function is periodically performed by a predetermined time;
the first failure detecting function estimates the pressure within the target region based on the temperature detected by the fuel temperature detecting device; and
the second failure detecting function is executed if a difference between an actual pressure detected by the pressure detecting device and a previously estimated pressure is smaller than a predetermined value, the previously estimated pressure being estimated based on the temperature detected by the fuel temperature detecting device during execution of the first failure detecting function that is previously performed.

13. The failure detecting device according to claim 10, wherein:
the leakage determination device is configured to stop determination of leakage if the fuel tank is being refueled during execution of the first failure detecting function or the second failure detecting function.

14. The failure determining device according to claim 11, wherein:
the first failure detection function includes a timer function that performs a timed leakage determination process in which a leakage determination operation is periodically performed with a predetermined time even during stopping of the vehicle engine.

15. The failure determining device according to claim 14, wherein:
the first failure detection device further includes a pre-determination function that is executed before the timer function,
the pre-determination function determines that no leakage occurs if the change of pressure within the target region within a predetermined time after closing the target region is out of a predetermined range, and
the pre-determination function suspends the determination of leakage if the change of pressure within the target region within the predetermined time after closing the target region is within the predetermined range.

16. The failure detecting device according to claim 10, wherein the closing device is a canister closed valve.

17. The failure detecting device according to claim 16, further comprising a mechanical positive and negative pressure valve provided in the atmospheric passage and arranged parallel to the canister closed valve, wherein the mechanical positive and negative pressure valve is configured to open both when the pressure within the target region exceeds a predetermined positive pressure and falls blow a predetermined negative pressure.

18. The failure detecting device according to claim 10, wherein the pressure applying device comprises a jet pump configured to produce a positive pressure by a venturi effect with a supply of a pressurized fuel from the fuel pump.
